(19) United States
(12) Patent Application Publication
(10) Pub. No.: US 2026/0195639 A1
(43) Pub. Date: Jul. 9, 2026

(54) DIFFERENTIALLY PRIVATE FEDERATED EXTREME GRADIENT BOOSTING

(71) Applicant: INTERNATIONAL BUSINESS MACHINES CORPORATION, Armonk, NY (US)

(72) Inventors: Yuya Jeremy Ong, San Jose, CA (US); Naoise Holohan, Maynooth (IE); Yi Zhou, San Jose, CA (US); Nathalie Baracaldo Angel, San Jose, CA (US)

(21) Appl. No.: 19/012,577

(22) Filed: Jan. 7, 2025

(51) Int. Cl. G06N 20/00; G06N 5/01

(52) U.S. Cl. CPC G06N 20/00; G06N 5/01

(57) ABSTRACT

Training a differential privacy-aware (DP-aware) machine learning model includes transmitting epsilon hyperparameters to federated learning (FL) nodes. A differential privacy-aware (DP-aware) machine learning model is generated based on noise-infused surrogate histograms received from the FL nodes, each noise-infused surrogate histogram based on an epsilon hyperparameter and representing a node-specific dataset. The DP-aware machine learning model is transmitted to the FL nodes. A DP-aware aggregate histogram is generated by merging DP-aware gradients and DP-aware Hessians determined by the FL nodes based on each FL node generating predictions by applying the DP-aware machine learning model to a node-specific dataset therein. A decision tree of the DP-aware machine learning model is expanded by dividing data in one or more decision tree nodes. The machine learning model is iteratively trained by successively merging further DP-aware gradients and DP-aware Hessians generated by FL nodes based on updated versions of the DP-aware machine learning model.

### BACKGROUND

This disclosure relates to machine learning, and, more particularly, to infusing differential privacy into machine learning models trained using federated learning with extreme gradient boosting (XGBoost).

Differential privacy is a paradigm for limiting the disclosure of private information during the compilation and use of data for statistical analysis and for machine learning. By injecting appropriately structured noise into the data, personal information may be masked, thereby limiting what can be learned about specific individuals whose data is part of the data compilation used for training a machine learning model. A process for training a machine learning model, for example, is differentially private if an observer is unable to ascertain whether a particular individual's information is part of the training corpus.

### SUMMARY

In one or more embodiments, training a differential privacy-aware (DP-aware) machine learning model includes transmitting, by a gradient boost (GB) aggregator, a plurality of epsilon hyperparameters to a plurality of federated learning (FL) nodes. Each epsilon hyperparameter is specific to a particular FL node. The method includes initializing, by the GB aggregator, a DP-aware machine learning model based on noise-infused surrogate histograms received from the plurality of FL nodes. Each noise-infused surrogate histogram represents data contained in a node-specific dataset of a corresponding FL node and comprises bins having bin sizes specified by the epsilon hyperparameter provided to the FL node. The method includes transmitting the DP-aware machine learning model to the plurality of FL nodes. The method includes generating, by the GB aggregator, a DP-aware aggregate histogram by merging a plurality of DP-aware gradients and DP-aware Hessians received from and determined by the plurality of FL nodes based on each FL node generating predictions by applying the DP-aware machine learning model to a node-specific dataset therein. The method includes expanding, by the GB aggregator, a decision tree of the DP-aware machine learning model by dividing data contained in one or more nodes of the decision tree. The method includes iteratively training, by the GB aggregator, the machine learning model by successively merging further DP-aware gradients and DP-aware Hessians generated by FL nodes based on updated versions of the DP-aware machine learning model.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example architecture of a gradient boost aggregator for training a machine learning model using federated learning with XGBoost.

FIG. 2 illustrates an example method of operation performed by the gradient boost aggregator of FIG. 1.

FIG. 3 illustrates certain operative aspects of the gradient boost aggregator of FIG. 1 related to determining epsilon values, or hyperparameters, for building noise-infused histograms.

FIGS. 4A-4C illustrate operations for infusing noise into a histogram generated using hyperparameters provided by the gradient boost aggregator of FIG. 1.

FIG. 5 illustrates an example exchange of data in which the gradient boost aggregator of FIG. 1 obtains DP-aware gradients and histograms determined by federated learning nodes based on a DP-aware machine learning model initialized by the gradient boost aggregator.

FIG. 6 illustrates an example operation for gradients and histograms determined based on the DP-aware machine learning model initialized by the gradient boost aggregator of FIG. 1

FIG. 7 illustrates certain operative aspects of generating a DP-aware aggregate histogram by the gradient boost aggregator of FIG. 1.

FIGS. 8A-C illustrate certain operative aspects of training a DP-aware machine learning model using federated learning with XGBoost by the gradient boost aggregator of FIG. 1.

FIG. 9 illustrates an example of a computing environment that is capable of implementing the gradient boost aggregator of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to employ the features described in virtually any appropriately detailed structure. Further, the terms and phrases used within this disclosure are not intended to be limiting, but rather to provide an understandable description of the features described.

This disclosure relates to machine learning, and, more particularly, to infusing differential privacy into machine learning models trained using federated learning with XGBoost. Boosting involves building a powerful model by sequentially adding up the results of so-called weak learners to iteratively build up a strong predictive model. The correct results of a weak learner are filtered out or underweighted relative to incorrect results, and a successor is trained on the difficult-to-predict residuals. The training process continues iteratively until a model structure emerges having strong predictive accuracy. Gradient boosting, as the name implies, is a form of boosting using gradient descent and is often applied in the context of decision trees. A decision tree is a non-parametric supervised learning algorithm used for both classification and regression. The decision tree is grown by optimally splitting a tree node into two or more sub-nodes. The split is based on dividing the node in the way that produces the highest information gain or the most significant loss-function reduction. XGBoost is an efficient and effective gradient boosting algorithm incorporating several notable enhancements. An important aspect of XGBoost is parallelism and hardware optimization. Federated XGBoost allows multiple parties to collaboratively train a shared tree-based model using local data specific to each party. Notwithstanding the benefits of training a machine learning model using federated learning with XGBoost, there remains the challenge of preserving the privacy of parties who contribute data during the training.

In accordance with the inventive arrangements described herein, methods, systems, and computer program products are provided that are capable of enhancing the privacy of parties who contribute data for training a machine learning model using federated learning with XGBoost. The inventive arrangements in various embodiments add differential privacy to features of the parties' data. In certain embodiments, the inventive arrangements add differential privacy to gradients and Hessians generated as part of the machine learning process using federated learning with XGBoost. The inventive arrangements in other embodiments generate data replacements for missing data and use the occurrence of missing data as a source noise for providing differential privacy.

In certain embodiments, an aggregator is implemented for training machine learning models using federated learning with XGBoost. A technical advantage of the aggregator is that the aggregator serves as a centrally positioned entity capable of sorting the parties' respective data. The centrality of the aggregator enables the aggregator to select optimal split candidates for building out the decision tree that is part of machine learning using XGBoost. An XGBoost split candidate is a potential value of a feature of the data for separating data into distinct groups. A candidate having the highest gain or greatest reduction in loss (measured by a predetermined loss function) is chosen to split the data, creating additional child nodes or leaves and adding another level to the decision tree.

An aspect of the inventive arrangements is an aggregator that, in certain embodiments, generates a differential privacy-aware (DP-aware) machine learning model by merging a plurality of noise-infused surrogate histograms produced by a plurality of computing nodes communicatively coupled with the aggregator via a communication channel. The DP-aware machine learning model is transmitted to, and used by, the computing nodes to generate predictions from which DP-aware gradients and DP-aware Hessians may be determined. With conventional XGBoost, the machine learning model that is initialized and transmitted is a source of vulnerability for exposing the underlying data. The inventive arrangements mitigate the vulnerability by injecting differential privacy noise into the model.

As used herein, “DP-aware” means injecting noise (also referred to as distraction) or randomness into data sufficient to make the source or identify of persons or organizations providing the data immune from, or at least significantly protected against, discovery by anyone with access to the data, and yet allows the data to retain information useful for a predefined purpose. Typically, the data is a large dataset. Different mechanisms may be used for injecting noise or randomness into the data to make the data DP-aware. These mechanisms include mathematical ones such as the Laplacian mechanism and the Gaussian mechanism. Discrete or categorical values can be randomized through random selection (e.g., using the exponential mechanism or randomized response).

Another aspect of the inventive arrangements pertains to another source of data vulnerability. The source of vulnerability is the gradients and Hessians determined from predictions generated by individual parties applying the DP-aware machine learning model to local data. With respect to privacy generally, any response to a query involving sensitive data poses a risk of leaking personal information. In the instant case, the gradients and Hessians may be calculated based on sensitive raw data, and thus, could be combined for example with external data that would allow reconstruction of the sensitive data. For example, in calculating the mean of a dataset of incomes, although the mean is a statistical measure of all the data, it nonetheless could indicate data includes the income of a specific individual known to have an extraordinarily high income because the individual's income would inordinately skew the result.

The inventive arrangements provide a federated learning environment that likewise mitigates this vulnerability with respect to the gradients and Hessians. In certain embodiments of the federated learning environment, parties that determine gradients and Hessians based on predictions generated by applying the DP-aware machine learning model to their own data enhance the privacy of that data by injecting DP noise into the gradients and Hessians to generate DP-aware gradients and DP-aware Hessians.

Another aspect of the inventive arrangements pertains the handling of “missing” data and use thereof in training a machine learning model, generally, and more specifically in making the machine learning DP-aware. As in machine learning generally, federated learning with XGBoost uses data comprised of samples in the form n-tuples, or feature vectors, whose n elements are specific values of different features. A sample, or n-tuple, in which the value of one or more features is unavailable or unusable (e.g., corrupted) is deemed missing data. In certain embodiments, the inventive arrangements impute the missing value(s) by randomly selecting value(s) from a range of possible values, generating with the original data and the imputed data a noise-infused histogram. In other embodiments, the inventive arrangements randomly select non-missing raw data and mark the data as missing, which is added as a separate bin and used with the rest of the data to generate a noise-infused histogram. Infusing the histograms with noise is intended to ensure that the histograms are DP-aware.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

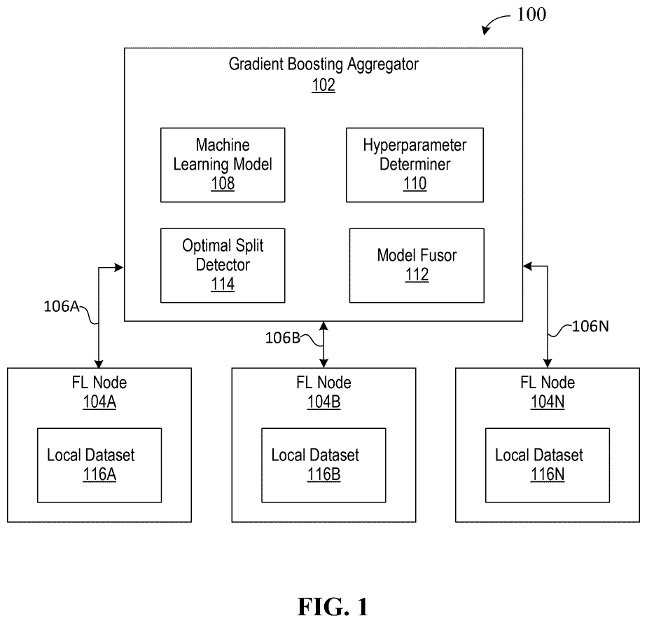

FIG. 1 illustrates an example machine learning framework 100 for training DP-aware machine learning models using a gradient boost (GB) aggregator 102 that facilitates federated learning with XGBoost. In the example architecture of FIG. 1, GB aggregator 102 facilitates machine learning by exchanging data with a plurality of participating parties identified as federated learning (FL) nodes 104a and 104b through 104n, each of which communicatively couples with GB aggregator 102 via communication channels 106a and 106b through 106n, respectively. Communication channels 106a-106n may each correspond to a specific FL node and may comprise one or more wired channels (e.g., Ethernet cable), wireless channels (e.g., Wi-Fi, Bluetooth, cellular network, satellite communication), optical channels (e.g., fiber optic cable), and/or other types of channels for facilitating data exchanges between GB aggregator 102 and FL nodes 104a-104n.

Illustratively, GB aggregator 102 includes machine learning model 108, hyperparameter determiner 110, model fusor 112, and optimal split detector 114. FL nodes 104a-104n illustratively include local datasets 116a and 116b through 116n, each local dataset specific to one of the FL nodes. GB aggregator 102 and FL nodes 104A-104N may be implemented in software that is executable on the hardware of one or more computers such as computer 901 (FIG. 9). GB aggregator 102 and FL nodes 104a-104n may execute on different devices at different geographic locations. For example, GB aggregator 102 may be a healthcare provider that exchanges data with disparately located health centers and/or hospitals. GB aggregator 102 may be a financial services provider that exchanges data with widely dispersed branch offices and financial centers. In all such arrangements, maintaining the privacy of the data exchanged is a crucial consideration.

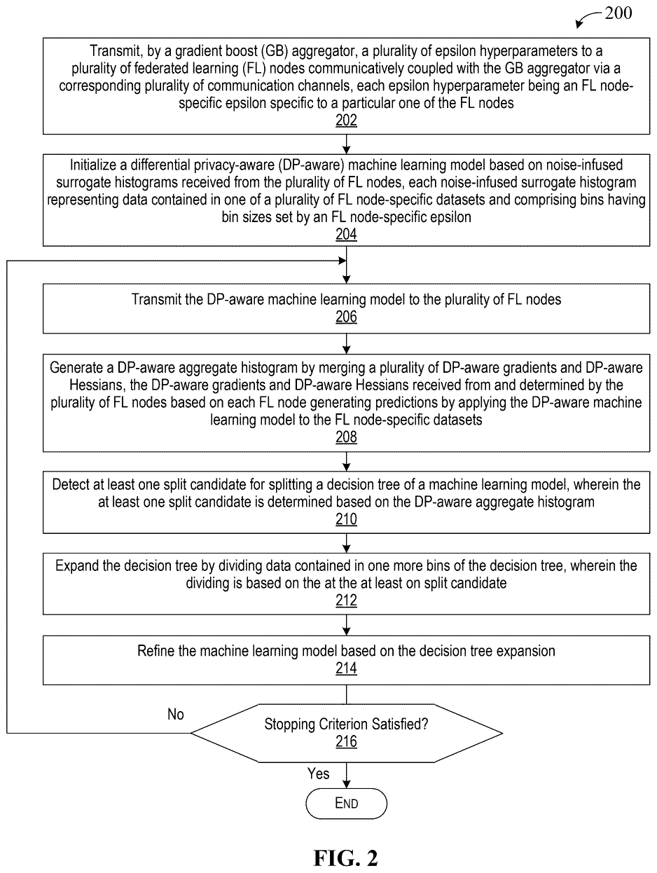

FIG. 2 illustrates an example method 200 of operation of GB aggregator 102 of machine learning framework 100 of FIG. 1 in training machine learning model 108 using federated learning with XGBoost.

Referring to FIGS. 1 and 2 collectively, in block 202, GB aggregator 102 transmits a plurality of epsilon hyperparameters to the plurality of FL nodes 104a-104n communicatively coupled with GB aggregator 102 via communication channels 106a-106n. Each of the epsilon hyperparameters is an FL node-specific epsilon that is specific to a particular one of FL nodes 104a-104n. In certain embodiments, the epsilon hyperparameters indicate the bin sizes of histograms generated by each FL node, each histogram representing the distribution of one of local datasets 116a-116n. Each FL node-specific epsilon is the ratio of the number of data samples contained in a local dataset of a specific FL node relative to the total number of samples in local datasets 116a-116n combined, the ratio multiplied by a global epsilon hyperparameter. The global epsilon hyperparameter is a feature using GB aggregator 102 to centralize the training of machine learning model 108 using local datasets 116a-116n of FL nodes 104a-104n. The global epsilon hyperparameter varies according to the specific prediction task that machine learning model 108 is being trained to perform, the epsilon parameter being relatively larger for classification tasks and relatively smaller for regression tasks, for example. The epsilons are communicated to the FL nodes 104a-104n to enable an appropriate parameterization of each FL node's own model as well as machine learning model 108. Epsilon values may be chosen to achieve a desired tradeoff between privacy and predictive accuracy of the model.

Regardless of the task, the FL node-specific epsilons may serve as thresholds to differentiate between small and large residuals during training of machine learning model 108, and as hyperparameters, can be tuned to control the trade-off between the model's robustness to outliers and the model's accuracy. The FL node-specific epsilons also provide information about the underlying distribution of the data contained in datasets 116a-116n. Hyperparameter determiner 110 computes a unique epsilon value for each of FL nodes 104a-104n based on the number of samples contained in datasets 116a-116n, as described above.

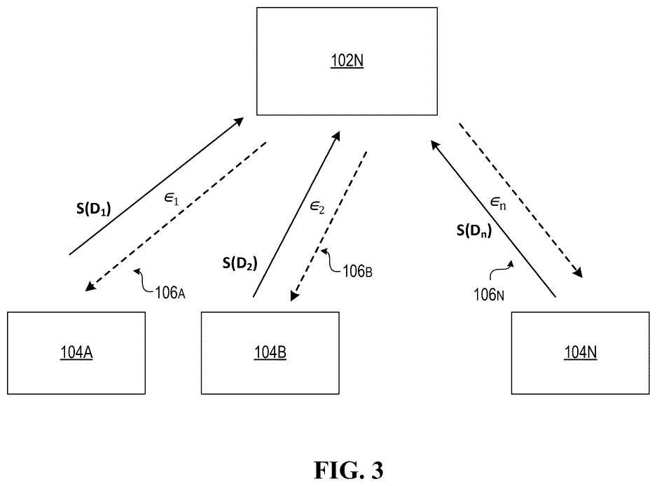

Referring additionally to FIG. 3, an embodiment of the process of determining the epsilon values is illustrated. Initially, GB aggregator 102 establishes a connection with each of FL nodes 104a-104n via communication channels 106a-106n, respectively, and transmits a query to each of the plurality of FL nodes requesting information pertaining to each FL node-specific dataset. FL nodes 104a-104n respond by transmitting certain statistics, S(D₁), S(D₂), . . . , S(Dₙ), derived from datasets 116a-116n, respectively. In certain embodiments, statistics, S(D₁), S(D₂), . . . , S(Dₙ), indicate the number of samples in each of datasets 116a-116n, based on which hyperparameter determiner 110 determines a sample ratio corresponding to each of FL nodes 104a-104n. Hyperparameter determiner 110 computes an FL node-specific epsilon ε₁, ε₂, . . . , εₙ for each of FL nodes 104a-104n, respectively. The FL node-specific epsilons, in certain embodiments, are based on the global epsilon and the individual sample ratios of each FL node. GB aggregator 102 transmits the respective FL node-specific epsilons to each of FL nodes 104a-104n via communication channels 106a-106n.

Each FL node uses its specific FL node-specific epsilon to construct a nose-infused surrogate histogram that represents one of datasets 116a-116n corresponding to the specific FL node. XGBoost uses histograms to approximate the distribution of datasets such as datasets 116a-116n. The histograms are used to efficiently calculate gradients and Hessians for determining the optimal or best split points in splitting a decision tree for training machine learning model 108 using XGBoost, as described in greater detail below.

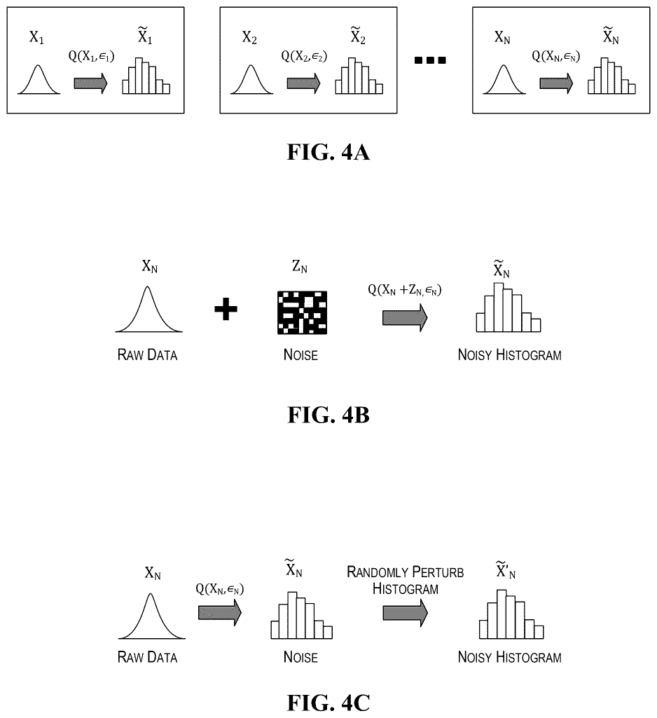

Referring additionally to FIGS. 4A, 4B, and 4C, a procedure is illustrated for infusing noise into the histograms created by FL nodes 104a-104n, according to certain embodiments. As illustrated in FIG. 4A, FL nodes 104a-104n segment the raw data of datasets 116a-116n, which illustratively have distributions X₁, X₂, . . . , Xₙ, respectively, into discrete bins (as specified by each respective epsilon value). The distributions are infused with noise to generate noise-infused surrogate histograms \tilde{X}₁, \tilde{X}₂, . . . , \tilde{X}ₙ. Example techniques for FL nodes 104 to generate noise infused histograms are illustrated in FIGS. 4B and 4C. FIG. 4B illustrates certain embodiments in which noise Zₙ is infused in the raw data prior to segmenting the data into discrete bins to create noise-infused histogram \tilde{X}ₙ. FIG. 4C illustrates certain embodiments in which the raw data is segmented into discrete bins to create a histogram and then noise is injected into the binned data to generate noise-infused histogram \tilde{X}ₙ.

Referring still to FIGS. 1 and 2, in block 204, GB aggregator 102 initializes machine learning model 108 based on the noise-infused surrogate histograms received from FL nodes 104a-104n. GB aggregator 102 based on the noise-infused surrogate histograms may determine the number of parameters, a learning rate, and other initial parameters (e.g., maximum XGBoost tree depth) for setting up machine learning model 108 for training with XGBoost. Each noise-infused surrogate histogram, as described above, represents data contained in a corresponding one of the plurality of FL node-specific datasets 116a-116n. The size of the bins of each noise-infused surrogate histogram has a bin size set by an FL-node specific epsilon.

GB aggregator 102, in certain embodiments, as part of initializing machine learning model 108 computes a joint average of noise-infused target value averages determined by FL nodes 104a-104n from each node-specific dataset of a corresponding FL node. That is, GB aggregator 102 computes an average of averages \tilde{Y}ᵢ, i=1, . . . , N computed by FL nodes 104a-104n with respect to target values of FL node-specific datasets 1106a-116n. The target values may be regression values or classification labels that serve as examples of predictions that machine learning model 108 should correctly generated once trained. In accordance with different embodiments described below, each target value average \tilde{Y}ᵢ is made DP aware.

As initialized, machine learning model 108 (illustratively represented as aggregator model f^{(A)}) is made DP aware by GB aggregator 102's taking the joint average of averages of the noise-infused target values generated as outputs of local machine learning models generated by each FL node. The joint average is a weighted average, in which each noise infused average is weighted by the number of samples nᵢ used to compute the i^{th} average, Y̅ᵢ:

$${f}^{( A )} = \frac{{\overline{Y}}_{1} {n}_{1} … + {\overline{Y}}_{N} {n}_{N}}{{n}_{1} + … + {n}_{N}} .$$

where Y̅, i=1, . . . , N is the i^{th} average of target values, and nᵢ, i=1, . . . , N is the number of data samples on which the i^{th} average, Y̅ᵢ, is based. The target values may be histogram frequencies—that is, the number of data samples appearing in each bin of the histogram—and are example values that the machine learning model is being trained to output (e.g., classification labels or regression values). In certain embodiments, the average Y̅ᵢ is made DP-aware by adding noise ϵᵢ to the target values prior to the averaging of the target values Yᵢ:

$${\overline{Y}}_{i} = avg ( {Y}_{i} + {ϵ}_{i} ) .$$

In Other Embodiments, Noise is Added to the Already-Computed Average:

$${\overline{Y}}_{i} = avg ( {Y}_{i} ) + {ϵ}_{i} .$$

Both embodiments, ensure that the joint average is DP-aware, since the joint average is an average of individual, weighted averages that are themselves DP-aware. That is, the joint average is an average of noise-infused averages, whereby infusing each individual average with noise mitigates the likelihood that information pertaining to any individual person or organization's data may be determined based on what may be learned from the joint average. Nonetheless, the effect of joint averaging—that is, averaging the noise-infused averages—tends to mitigate data distortion due to the injection of noise into the individual averages of the target values. The joint averaging enhances data accuracy while simultaneously preserving DP awareness, which protects against discovery of the identities of individual persons or organizations whose raw data forms FL node-specific datasets 116a-116n.

In block 206, GB aggregator 102 transmits to FL nodes 104a-104n machine learning model 108, as initialized, with the DP-aware joint average of target averages.

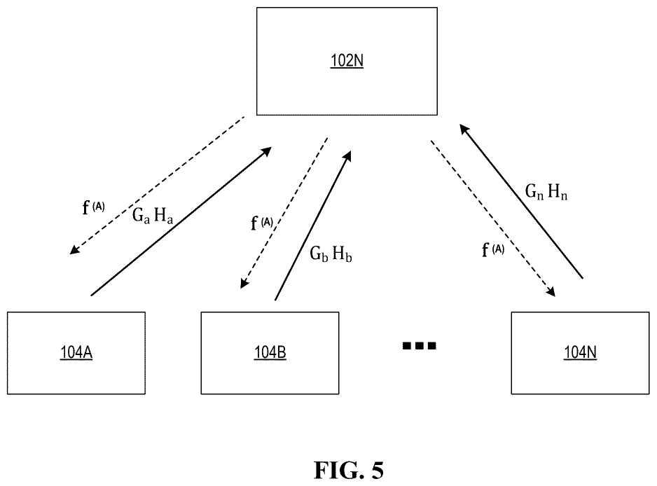

Referring additionally to FIG. 5, GB aggregator 102 transmits initialized machine learning model 108 (again, illustratively represented by aggregator model, f^{(A)}) to each of FL nodes 104a-104n. FL nodes 104a-104n generate gradients and Hessians that are derived by applying machine learning model 108 to FL node-specific datasets 116a-116n. FL nodes 104a-104n apply machine learning model 108 by inputting a corresponding FL node-specific dataset into the machine learning model, as initialized. The deviation between each prediction and joint average is an error or residual. Using a predetermined loss function, such as mean squared error (MSE) for regression or, for classification, a logistic loss (binary classification) or softmax loss (multiclass classification) function, FL nodes 104a-104n compute gradients and Hessians of the loss function with respect to the predicted values. Illustratively, FL nodes 104a-104n in FIG. 5 generate gradients Gₐ and G_{b} through Gₙ along with Hessians (matrices) Hₐ and H_{b} through Hₙ with respect to the predicted values determined based on aggregator model, f^{(A)}—that is, machine learning model 108, as initialized. The gradients and Hessians from FL nodes 104a-104n are transmitted to GB aggregator 102.

GB aggregator 102, as described below, uses successively generated gradients and Hessians received from FL nodes 104a-104n to iteratively generate successive versions of a gradient boost decision tree for training machine learning model 108. The gradients and Hessians may be used to compute the gain associated with specific splits that expand the decision tree for training machine learning model 108 using XGBoost.

Thus, the respective gradients and Hessians determined by FL nodes 104a-104n are used for GB aggregator 102's training machine learning model 108. The first iteration of gradients and Hessians are determined based on the predictions generated by each FL node applying the machine learning model 108, as initialized, to its own FL node-specific dataset, as described. GB aggregator 102 uses the gradients and Hessians received from FL nodes 104a-104n to construct an aggregated histogram. GB aggregator 102 determines from the aggregated histograms optimal data splits to expand the decision tree for training machine learning model 108. As described below, with each subsequent iteration of training, FL nodes 104a-10n generate updated gradients and Hessians, which likewise are transmitted to GB aggregator 102 to further expand the decision tree based on which machine learning model 108 is trained.

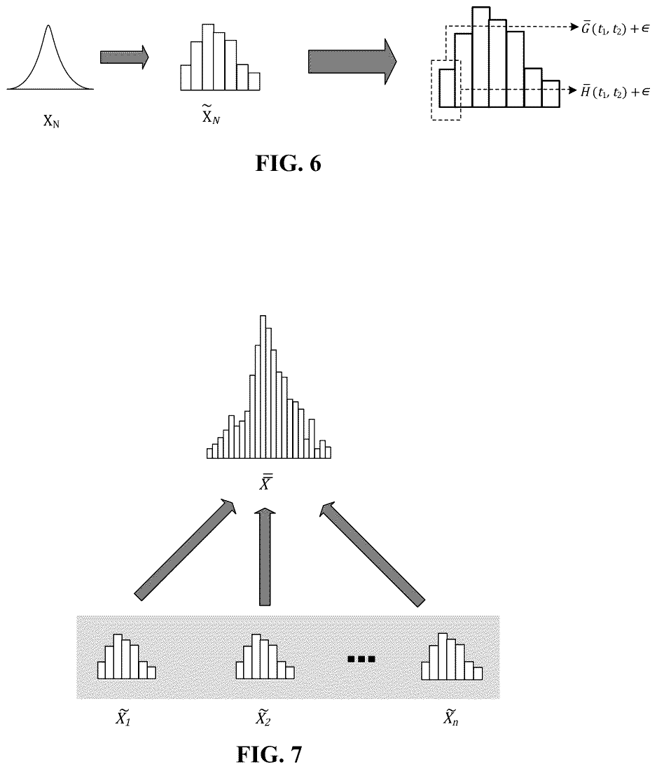

Referring additionally to FIG. 6, the gradients and Hessians are made DP aware by introducing noise ϵ into an average of gradient values and Hessian values computed for each bin of a corresponding surrogate histogram:

$${\overline{G}}_{( t 1 , t 2 )} + ϵ and {\overline{H}}_{( t 1 , t 2 )} + ϵ ,$$

where data distribution Xₙ is represented by histogram \tilde{X}ₙ, where G̅_{(t1,t2)} is an average of the gradients computed for data samples within the bin whose initial and ending thresholds are t1 and t2, respectively, and where H̅_{(t1,t2)} is the Hessian of the same binned values.

In block 208, GB aggregator 102 generates a DP-aware aggregate histogram based on merging a plurality of DP-aware gradients and DP-aware Hessians and DP-aware histograms. The histograms, gradients, and Hessians are made DP-aware by the injection of noise into the gradients and Hessians, as described above. Generating the aggregate histogram based on the noise-infused histograms, gradients, and Hessians ensures that the aggregate histogram is likewise DP-aware. As with combining the noise-infused histograms, the merging of the DP-aware gradients and Hessians tends to mitigate relative effect of the noise in training machine learning model 108.

The DP-aware gradients and DP-aware Hessians are received from and determined by FL nodes 104a-104n based on each FL node's generating predictions by applying machine learning model 108, as initialized, to a corresponding FL node-specific dataset the DP-aware machine learning model initialized and transmitted to each FL node by GB aggregator 102.

Referring additionally to FIG. 7, GB aggregator 102 illustratively generates DP-aware aggregate histogram X̅ based on the DP-aware gradients and Hessians that are received by GB aggregator 102 from the plurality of FL nodes 104a-104n and by model fusor 112 fusing FL node-specific surrogate histograms \tilde{X}₁, \tilde{X}₂, . . . , \tilde{X}ₙ. In certain embodiments, model fusor 112 fuses surrogate histograms using Federated Quantile Sketch Fusion, which is a known process of combining quantile sketches (approximate quantiles) from different sources to estimate quantiles and approximate statistical properties of the sources' data independent of the raw data itself. Model fusor 112 constructs a surrogate index from feature values and from bin indexes corresponding to the FL node-specific histograms. The surrogate index is an aggregation of the values and bin indexes of the histograms. Model fusor 112, based on the sizes of the individual histograms' bins and on the task for which machine learning model 108 is being trained (e.g., regression or classification), determines the bin sizes for the features of DP-aware aggregate histogram X̅. The DP-aware aggregate histogram X̅ is constructed using the bin sizes and surrogate index. Once constructed, the DP-aware aggregate histogram X̅ provides a representation of all raw values of the training data comprising datasets 116a-116n and can be used for training machine learning model 108 according to the following procedures.

Referring still to FIGS. 1 and 2, in block 210 optimal split detector 114 detects at least one split candidate for splitting a decision tree of machine learning model 108. The split candidate(s) are detected based on the DP-aware aggregate histogram. Each split candidate is a potential point for dividing histogram-binned data, thereby further segmenting data and expanding the decision tree with XGBoost. In training machine learning model 108 using XGBoost, optimal split detector 114 considers each split candidate and determines the one(s) that results in the highest gain or most significant reduction in loss to enhance the predictive accuracy of machine learning model 108.

In block 212, optimal split detector 114 expands the decision tree. The decision tree is expanded by dividing data contained in one or more nodes of the decision tree. Each splitting adds tree nodes and an additional tree layer. The dividing is based on an optimal selection by optimal split detector 114 of the split candidate(s) detected in block 210. Growing the decision tree in this way refines machine learning model 108 and enhances the model's predictive accuracy accordingly. Split detection and splitting are known XGBoost processes, but in accordance with the inventive arrangements disclosed herein, are performed on the DP-aware aggregate histogram created as described above.

In block 214, GB aggregator 102 refines machine learning model 108 based on the decision tree expansion in block 212. If at decision block 216, a predetermined stopping criterion is satisfied, then iterative training of machine learning model stops. Otherwise, iterative training of machine learning model 108 continues, beginning anew in block 206 with the model now refined through the processes in blocks 208 through 214 and proceeds again by repeating the processes.

GB aggregator 102 iteratively trains machine learning model 108 by successively merging newly generated DP-aware gradients and DP Hessians, which are newly generated by FL nodes 104a-104n based on updating machine learning model 108 with each tree expansion and iteratively expanding the decision tree by identifying additional split candidates until a predetermined stopping criterion is achieved. Machine learning model 108 is refined with each optimal decision tree split. With each refinement or iteration, GB aggregator 102 transmits the refined machine learning model to FL nodes 104a-10n. Predictions generated by the FL nodes 104a-104n applying the newly refined machine learning model 108 enable the FL nodes to generate new gradients and Hessians. The newly generated gradients and Hessians permit further decision tree splitting, with a concomitant refinement of machine learning model 108. Because each newly generated gradient and Hessian is DP aware, as are the model refinements as described above, the DP awareness of machine learning model 108 is preserved with each training iteration.

The training of machine learning model 108 continues until the predetermined stopping criterion is achieved. The stopping criterion may, in certain arrangements, occur with the predictions generated by FL nodes with machine learning model 108, as now refined, exhibiting an acceptable level of predictive accuracy. In other arrangements, the stopping criterion may include model convergence wherein machine learning model 108 does not appreciably change from one training iteration to the next (e.g., predictive accuracy of the model increases less than 5 or 10 percent, or even declines with overfitting). The stopping criterion, in still other arrangements, may be the tree splitting resulting in a maximum number of levels of the decision tree.

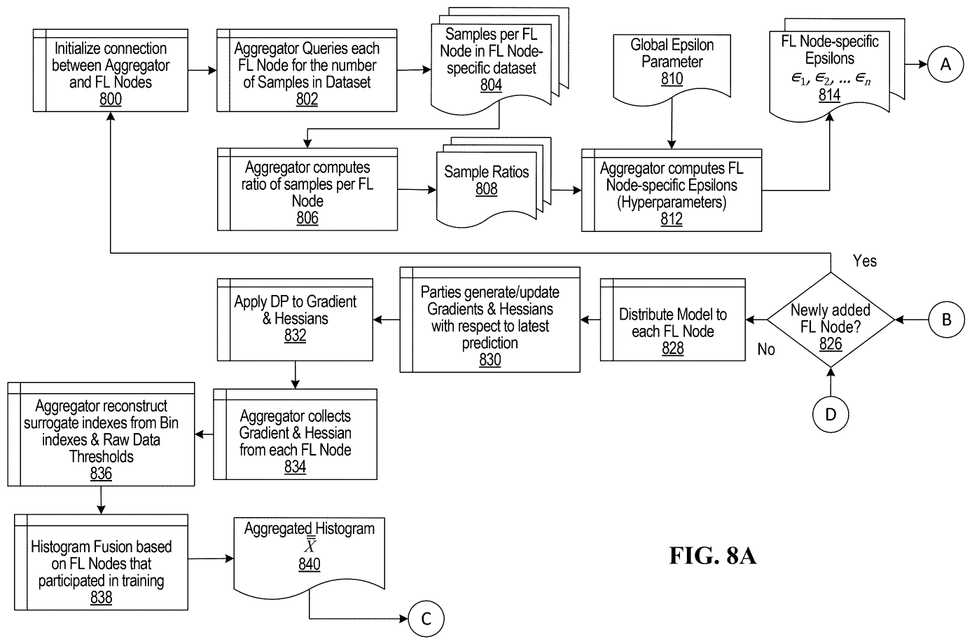

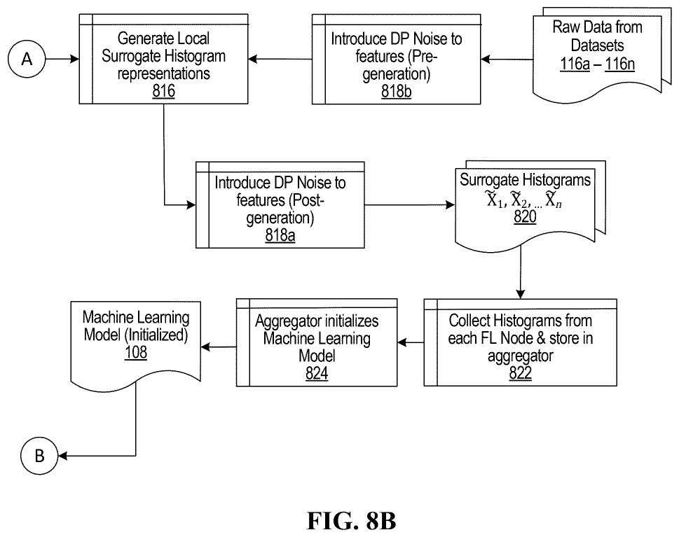

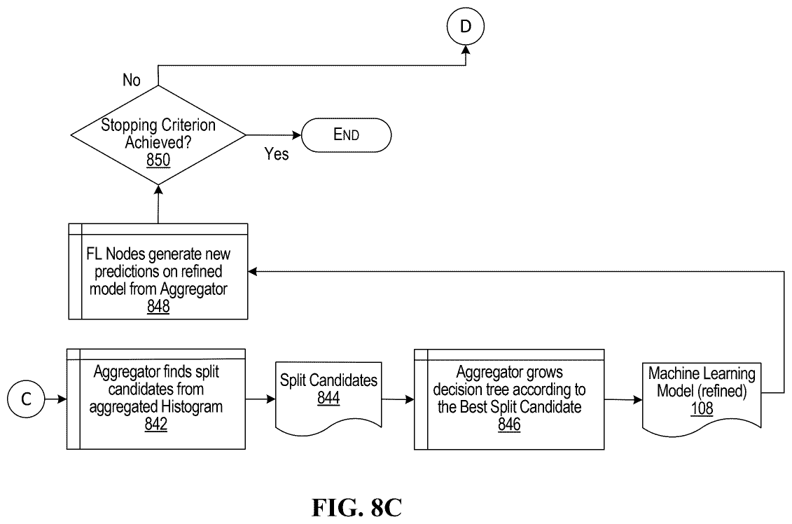

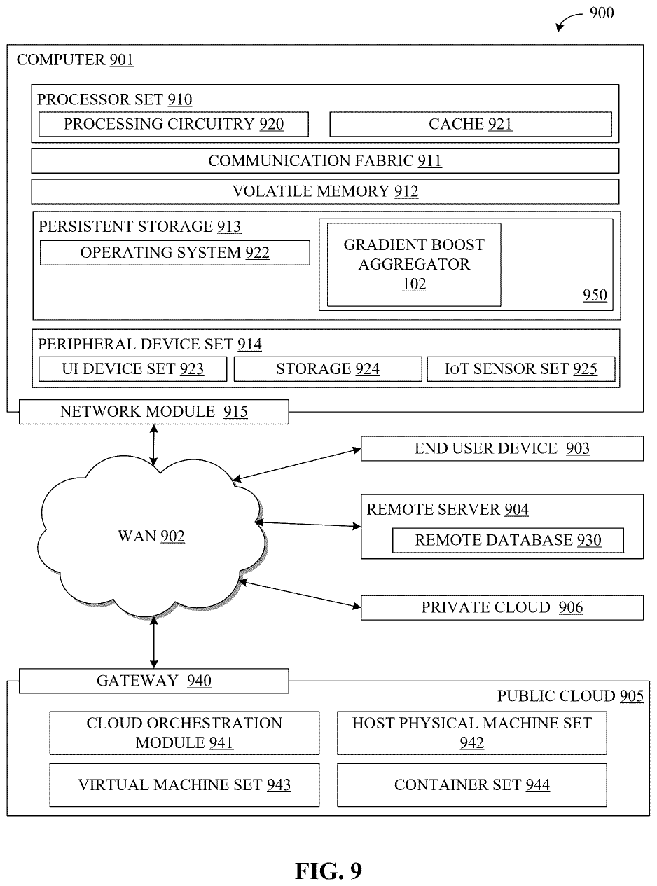

FIGS. 8A-C illustrate aspects of training machine learning model 108 using the federated learning with XGBoost described above with reference to FIGS. 1-7 but incorporating certain additional features, including an option for admitting one or more new FL nodes during the training. In block 800, GB aggregator 102 (simply “Aggregator” in the figure) initiates a connection via communication channels 106a-106n to FL nodes 104, and in block 802 queries each FL node for the number of samples in each FL node's dataset. Receiving responses 804 giving the number of samples per FL node-specific dataset, GB aggregator 102 in block 806 computes sample ratios 808. Using the received information and predetermined global epsilon parameter 810, GB aggregator computes FL node-specific epsilons ε₁, ε₂, . . . , εₙ 814 for each of the FL nodes in block 812. As noted, the FL node-specific epsilons are transmitted from GB aggregator 102 to the respective FL nodes 104.

In block 816, the FL nodes generate surrogate histograms \tilde{X}₁, \tilde{X}₂, . . . , \tilde{X}ₙ 820. Block 818a illustrates certain embodiments in which a histogram is made DP-aware by introducing noise after generation of the histogram. Block 818b illustrates certain embodiments in which the histogram is made DP-aware by being generated using raw data (from datasets 116a-116n) in which noise is introduced to the raw data prior to generation of the histogram. GB aggregator 102 in block 822 collects and electronically stores surrogate histograms \tilde{X}₁, \tilde{X}₂, . . . , \tilde{X}n 820. Based on the histogram data, GB aggregator 102 in block 824 initializes machine learning model 108. If it is determined at decision block 826 that, in the interim, another FL node has been newly added to the federation of nodes, then the process returns to block 800 and begins anew for the sake of incorporating newly added data. Otherwise, in block 828, GB aggregator 102 distributes machine learning model 108, as initialized, to each of the FL nodes 104. The FL nodes in block 830 generate gradients and Hessians (in subsequent training iterations, the FL nodes update previously generated gradients and Hessians). The gradients and Hessians are derived from predictions generated by applying machine learning model 108 as initialized (in subsequent training iterations, the machine learning model 108 will have been refined through subsequent tree splitting operations) to the FL node-specific datasets. The gradients and Hessians, whether initially generated or subsequently updated, are made DP-aware by adding noise to computed averages in block 832, as described above.

GB aggregator 102 collects the gradients and Hessians transmitted from each FL node in block 834, and in block 836 may reconstruct the surrogate indexes from the bin indexes and the raw data thresholds for binning the data to form the surrogate histograms, as also described above. The reconstructing is for the sake of fusing the FL node-specific histograms generated by the FL nodes (the ones that participate in the current iteration of training). In block 838, GB aggregator 102 generates DP-aware aggregate histogram X̅ 840 based on the fusing. GB aggregator 102 in block 842 detects split candidates 844 with respect to DP-aware aggregate histogram X̅, and in block 846 grows the decision tree by splitting the decision tree at one or more data points corresponding to the optimal or “best” split candidate(s), thereby refining machine learning model 108. GB aggregator 102 in block 846 synchronizes machine learning model 108, as refined, sending the refined version of the model to each of the FL nodes.

The FL nodes generate new predictions at block 848 by applying machine learning model 108, as refined. If at decision block 850, the stopping criterion is achieved with the now-complete current iteration of training, then no further training occurs. If the stopping criterion is not achieved, then training continues anew at block 828 using the now-refined version of machine learning model 108, or if a new FL node has joined in the interim, beginning again in block 800.

In certain embodiments, each of the noise-infused surrogate histograms is generated by randomly selecting a value from a range of possible values in response to detecting a missing value in one of the FL node-specific datasets and substituting the value randomly selected for the missing value. The range of possible values lies within a noise-infused distribution, which is a distribution of values to which noise has been added. In other embodiments, each of the noise-infused surrogate histograms is generated by randomly selecting one or more non-missing values from a FL node-specific dataset, marking data corresponding to the one or more values as missing, and discarding values marked as missing from the FL node-specific dataset. Values may be randomly selected up to a predetermined maximum. For example, the maximum may be a percentage of the total number of samples in the dataset, where the percentage is based on an average number of missing values in the same or other similar types of datasets. Discarding values marked as missing ensures that it is possible that the FL node-specific dataset includes missing data, thereby making it difficult to leverage missing data to discover private information. In certain embodiments, the procedures can be combined by randomly selecting substitutes for missing data and discarding non-missing data as though it were missing. The combination ensures the robustness of machine learning model 108 trained using the data while providing privacy protection. That is, replacement of missing data enhances predictive accuracy of the model, and randomly discarding other data (albeit in a smaller amount than is substituted) promotes privacy.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 9, computing environment 900 contains an example of an environment for the execution of at least some of the computer code in block 950 involved in performing the inventive methods, such as implementing GB aggregator 102 for training DP-aware machine learning models using federated learning with XGBoost. GB aggregator 102 facilitates training a DP-aware machine learning model using data from different datasets of multiple, disparately located computing nodes operating as FL parties or FL nodes.

Computing environment 900 includes, for example, computer 901, wide area network (WAN) 902, end user device (EUD) 903, remote server 904, public cloud 905, and private cloud 906. In certain embodiments, for example, GB aggregator 102 may be implemented in remote server 904. GB aggregator 102 and/or one or more FL nodes 104a-104n, in some embodiments, may be implemented as part of public cloud 905. In other embodiments, GB aggregator 102 and/or one or more FL nodes 104a-104n may be implemented as part of private cloud 906.

In certain embodiments, computer 901 includes processor set 910 (including processing circuitry 920 and cache 921), communication fabric 911, volatile memory 912, persistent storage 913 (including operating system 922 and block 950, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

Computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

Processor set 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

Communication fabric 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

Persistent storage 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid-state storage devices. Operating system 922 may take several forms, such as various known proprietary operating systems or open-source Portable Operating System Interface type operating systems that employ a kernel. The code included in block 950 typically includes at least some of the computer code involved in performing the inventive methods.

Peripheral device set 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (e.g., where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

Network module 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (e.g., embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 903 is any computer system that is used and controlled by an end user (e.g., a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

Remote server 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

Public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The terminology used herein is for the purpose of describing particular embodiments only and is not intended to be limiting. Notwithstanding, several definitions that apply throughout this document now will be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), a graphics processing unit (GPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
transmitting, by a gradient boost (GB) aggregator, a plurality of epsilon hyperparameters to a plurality of federated learning (FL) nodes, wherein each epsilon hyperparameter is specific to a particular FL node;
initializing, by the GB aggregator, a differential privacy-aware (DP-aware) machine learning model based on noise-infused surrogate histograms received from the plurality of FL nodes, wherein each noise-infused surrogate histogram represents data contained in a node-specific dataset of a corresponding FL node and comprises bins having bin sizes specified by the epsilon hyperparameter provided to the FL node;
transmitting the DP-aware machine learning model to the plurality of FL nodes;
generating, by the GB aggregator, a DP-aware aggregate histogram by merging a plurality of DP-aware gradients and DP-aware Hessians received from and determined by the plurality of FL nodes based on each FL node generating predictions by applying the DP-aware machine learning model to a node-specific dataset therein;
expanding, by the GB aggregator, a decision tree of the DP-aware machine learning model by dividing data contained in one or more nodes of the decision tree; and
iteratively training, by the GB aggregator, the machine learning model by successively merging further DP-aware gradients and DP-aware Hessians generated by FL nodes based on updated versions of the DP-aware machine learning model.

2. The computer-implemented method of claim 1, wherein the initializing includes computing, by the GB aggregator, a joint average of noise-infused target value averages determined by the plurality of FL nodes from each node-specific dataset of a corresponding FL node.

3. The computer-implemented method of claim 1, wherein each of the noise-infused surrogate histograms is generated by adding noise to raw data from a FL node-specific dataset prior to generating a corresponding noise-infused surrogate histogram based on the raw data.

4. The computer-implemented method of claim 1, wherein each of the noise-infused surrogate histograms is generated by generating a surrogate histogram based on raw data from a FL node-specific dataset and adding noise to the surrogate histogram to generate the corresponding noise-infused surrogate histogram.

5. The computer-implemented method of claim 1, wherein the DP-aware gradients and DP-aware Hessians are computed by adding noise to averages of gradients and Hessians determined from the predictions generated by applying the DP-aware machine learning model to each FL node-specific dataset.

6. The computer-implemented method of claim 1, wherein each of the noise-infused surrogate histograms is generated by randomly selecting a value from a range of possible values in response to detecting a missing value in one of the FL node-specific datasets and substituting the value randomly selected for the missing value, wherein the range of possible values lies within a noise-infused distribution.

7. The computer-implemented method of claim 1, wherein each of the noise-infused surrogate histograms is generated by selecting one or more non-missing values for data in a FL node-specific dataset, marking data corresponding to the one or more non-missing values as missing, and discarding values marked as missing.

8. A system, comprising:
one or more processors capable of initiating operations including:
transmitting, by a gradient boost (GB) aggregator, a plurality of epsilon hyperparameters to a plurality of federated learning (FL) nodes, wherein each epsilon hyperparameter is specific to a particular FL node;
initializing, by the GB aggregator, a differential privacy-aware (DP-aware) machine learning model based on noise-infused surrogate histograms received from the plurality of FL nodes, wherein each noise-infused surrogate histogram represents data contained in a node-specific dataset of a corresponding FL node and comprises bins having bin sizes specified by the epsilon hyperparameter provided to the FL node;
transmitting the DP-aware machine learning model to the plurality of FL nodes;
generating, by the GB aggregator, a DP-aware aggregate histogram by merging a plurality of DP-aware gradients and DP-aware Hessians received from and determined by the plurality of FL nodes based on each FL node generating predictions by applying the DP-aware machine learning model to a node-specific dataset therein;
expanding, by the GB aggregator, a decision tree of the DP-aware machine learning model by dividing data contained in one or more nodes of the decision tree; and
iteratively training, by the GB aggregator, the machine learning model by successively merging further DP-aware gradients and DP-aware Hessians generated by FL nodes based on updated versions of the DP-aware machine learning model.

9. The system of claim 8, wherein the initializing includes computing, by the GB aggregator, a joint average of noise-infused target value averages determined by the plurality of FL nodes from each node-specific dataset of a corresponding FL node.

10. The system of claim 8, wherein each of the noise-infused surrogate histograms is generated by adding noise to raw data from a FL node-specific dataset prior to generating a corresponding noise-infused surrogate histogram based on the raw data.

11. The system of claim 8, wherein each of the noise-infused surrogate histograms is generated by generating a surrogate histogram based on raw data from a FL node-specific dataset and adding noise to the surrogate histogram to generate the corresponding noise-infused surrogate histogram.

12. The system of claim 8, wherein the DP-aware gradients and DP-aware Hessians are computed by adding noise to averages of gradients and Hessians determined from the predictions generated by applying the DP-aware machine learning model to each FL node-specific dataset.

13. The system of claim 8, wherein each of the noise-infused surrogate histograms is generated by randomly selecting a value from a range of possible values in response to detecting a missing value in one of the FL node-specific datasets and substituting the value randomly selected for the missing value, wherein the range of possible values lies within a noise-infused distribution.

14. A computer program product, the computer program product comprising:
one or more computer-readable storage media and program instructions collectively stored on the one or more computer-readable storage media, the program instructions executable by a processor to cause the processor to initiate operations including:
transmitting, by a gradient boost (GB) aggregator, a plurality of epsilon hyperparameters to a plurality of federated learning (FL) nodes, wherein each epsilon hyperparameter is specific to a particular FL node;
initializing, by the GB aggregator, a differential privacy-aware (DP-aware) machine learning model based on noise-infused surrogate histograms received from the plurality of FL nodes, wherein each noise-infused surrogate histogram represents data contained in a node-specific dataset of a corresponding FL node and comprises bins having bin sizes specified by the epsilon hyperparameter provided to the FL node;
transmitting the DP-aware machine learning model to the plurality of FL nodes;
generating, by the GB aggregator, a DP-aware aggregate histogram by merging a plurality of DP-aware gradients and DP-aware Hessians received from and determined by the plurality of FL nodes based on each FL node generating predictions by applying the DP-aware machine learning model to a node-specific dataset therein;
expanding, by the GB aggregator, a decision tree of the DP-aware machine learning model by dividing data contained in one or more nodes of the decision tree; and
iteratively training, by the GB aggregator, the machine learning model by successively merging further DP-aware gradients and DP-aware Hessians generated by FL nodes based on updated versions of the DP-aware machine learning model.

15. The computer program product of claim 14, wherein the initializing includes computing, by the GB aggregator, a joint average of noise-infused target value averages determined by the plurality of FL nodes from each node-specific dataset of a corresponding FL node.

16. The computer program product of claim 14, wherein each of the noise-infused surrogate histograms is generated by adding noise to raw data from a FL node-specific dataset prior to generating a corresponding noise-infused surrogate histogram based on the raw data.

17. The computer program product of claim 14, wherein each of the noise-infused surrogate histograms is generated by generating a surrogate histogram based on raw data from a FL node-specific dataset and adding noise to the surrogate histogram to generate the corresponding noise-infused surrogate histogram.

18. The computer program product of claim 14, wherein the DP-aware gradients and DP-aware Hessians are computed by adding noise to averages of gradients and Hessians determined from the predictions generated by applying the DP-aware machine learning model to each FL node-specific dataset.

19. The computer program product of claim 14, wherein each of the noise-infused surrogate histograms is generated by randomly selecting a value from a range of possible values in response to detecting a missing value in one of the FL node-specific datasets and substituting the value randomly selected for the missing value, wherein the range of possible values lies within a noise-infused distribution.

20. The computer program product of claim 14, wherein each of the noise-infused surrogate histograms is generated by selecting one or more non-missing values for data in a FL node-specific dataset, marking data corresponding to the one or more non-missing values as missing, and discarding values marked as missing.
